(19) United States
(12) Patent Application Publication
(10) Pub. No.: US 2017/0190280 A1
(43) Pub. Date: Jul. 6, 2017

(54) Detachable Vehicular Lighting Device

(71) Applicant: Alexis Guillen-Fierro, Redland, FL (US)

(72) Inventor: Alexis Guillen-Fierro, Redland, FL (US)

(21) Appl. No.: 14/987,388

(22) Filed: Jan. 4, 2016

(51) Int. Cl. B60Q 1/26; B60Q 1/50; B60Q 1/00

(52) U.S. Cl. CPC B60Q 1/2615; B60Q 1/0076; B60Q 1/2696; B60Q 1/50

(57) ABSTRACT

A detachable vehicular lighting device for identifying vehicles traveling in a caravan includes a housing that has a bottom that is substantially rectangular. The bottom has an outer perimeter and an opening that defines an inner perimeter. An outer casing is coupled to the outer perimeter and extends transversely from the bottom. An inner casing, coupled to the inner perimeter, defines a cavity positioned in the bottom of the housing. The bottom, the outer casing and the inner casing define an internal space. A power module and a plurality of lights are coupled to the housing and positioned in the internal space. The lights are operationally coupled to the power module. A switch is operationally coupled to the power module and the plurality of lights. A fastener, coupled to the bottom, is configured to couple the housing to the exterior surface of a vehicle.

### BACKGROUND OF THE DISCLOSURE

### Field of the Disclosure

The disclosure relates to lighting devices and more particularly pertains to a new lighting device for identifying vehicles traveling in a caravan.

### SUMMARY OF THE DISCLOSURE

An embodiment of the disclosure meets the needs presented above by generally comprising a housing that has a bottom that is substantially rectangular. The bottom has an outer perimeter and an opening that defines an inner perimeter. An outer casing is coupled to the outer perimeter and extends transversely from the bottom. An inner casing, coupled to the inner perimeter, defines a cavity positioned in the bottom of the housing. The bottom, the outer casing and the inner casing define an internal space. A power module and a plurality of lights are coupled to the housing and positioned in the internal space. The lights are operationally coupled to the power module. A switch is operationally coupled to the power module and the plurality of lights. A fastener, coupled to the bottom, is configured to couple the housing to the exterior surface of a vehicle.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a detachable vehicular lighting device according to an embodiment of the disclosure.

FIG. 2 is a bottom view of an embodiment of the disclosure.

FIG. 3 is a side view of an embodiment of the disclosure.

FIG. 4 is an end view of an embodiment of the disclosure.

FIG. 5 is an end view of an embodiment of the disclosure.

FIG. 6 is an isometric perspective view of an embodiment of the disclosure.

FIG. 7 is an in-use view of an embodiment of the disclosure.

### DESCRIPTION OF THE PREFERRED EMBODIMENT

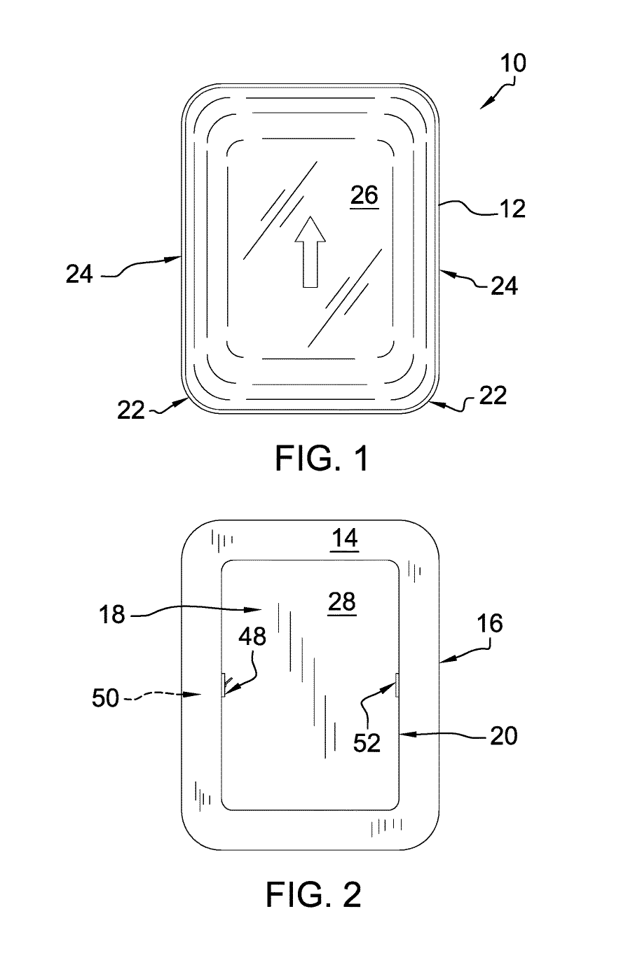

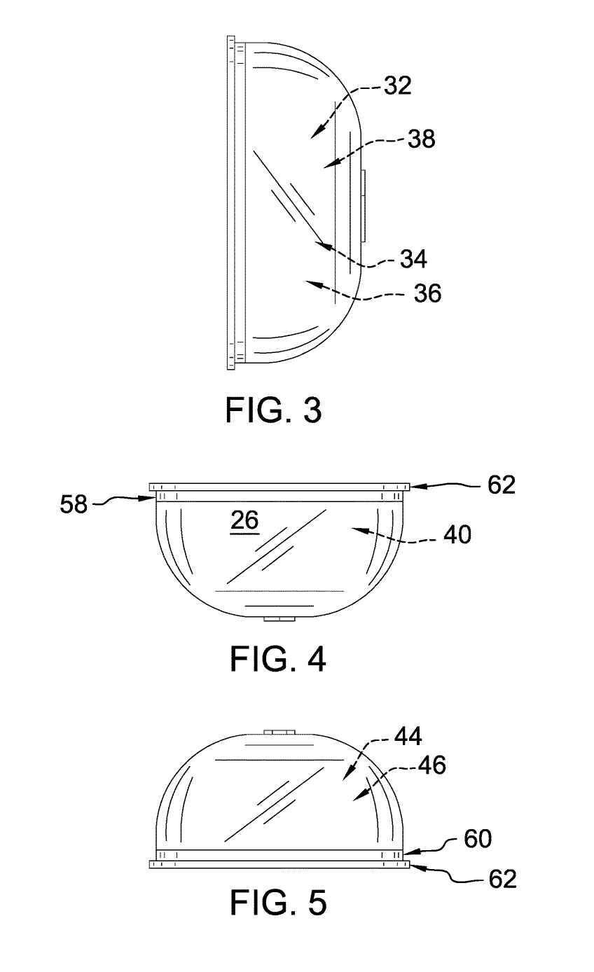

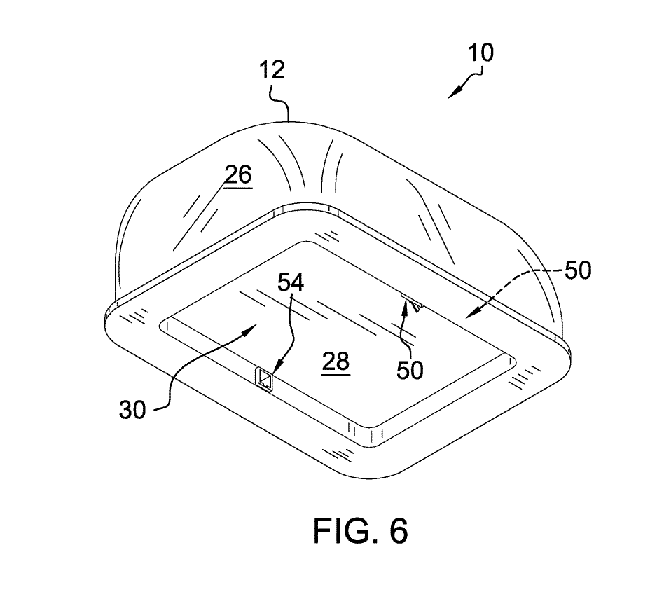

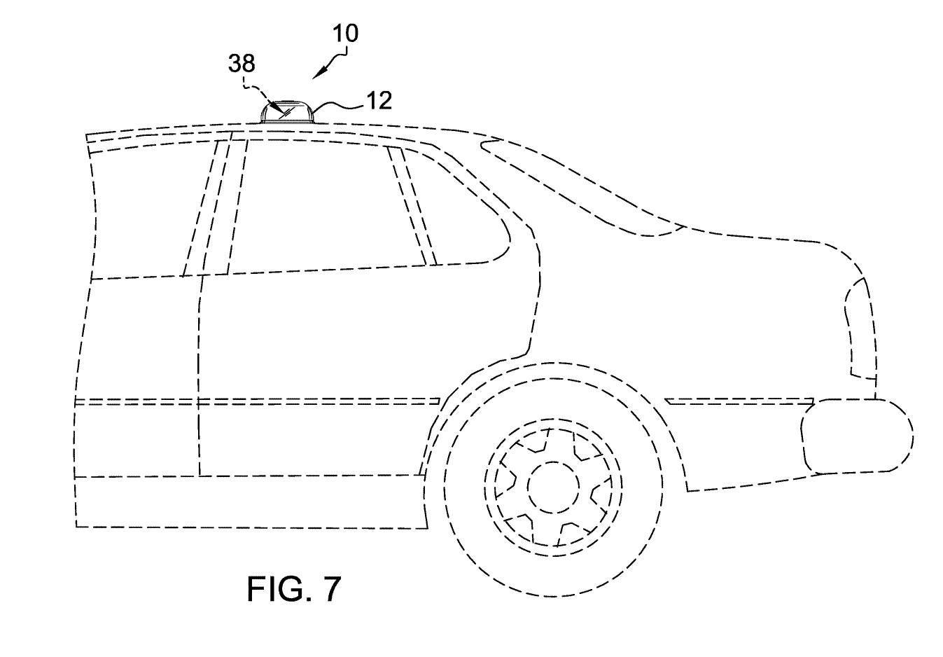

With reference now to the drawings, and in particular to FIGS. 1 through 7 thereof, a new lighting device embodying the principles and concepts of an embodiment of the disclosure and generally designated by the reference numeral 10 will be described.

As best illustrated in FIGS. 1 through 7, the detachable vehicular lighting device 10 generally comprises a housing 12 that has a bottom 14. The bottom 14 is substantially rectangular and has an outer perimeter 16. The bottom 14 has an opening 18 that defines an inner perimeter 20. The bottom 14 has corners 22 that are rounded and a pair of elongated sides 24. An outer casing 26 is coupled to the outer perimeter 16 and extends transversely from the bottom 14. The outer casing 26 is rounded, such that the housing 12 is domed. An inner casing 28 is coupled to the inner perimeter 20. The inner casing 28 coextends with the outer casing 26. The inner casing 28 defines a cavity 30 positioned in the bottom 14 of the housing 12. The bottom 14, the outer casing 26 and the inner casing 28 define an internal space 32. The housing 12 is rigid and comprises plastic. Preferably, the housing 12 comprises hardened plastic.

A power module 34 is coupled to the housing 12 and positioned in the internal space 32. The power module 12 comprises at least one battery 36. A plurality of lights 38 is coupled to the housing 12 and positioned in the internal space 32. The lights 38 are operationally coupled to the power module 34. The plurality of lights 38 comprises light emitting diodes 40. In one embodiment of the invention, the plurality of lights 38 comprises white light emitting diodes 42 and the outer casing 26 is absorbent of light, except for red light and blue light. In another embodiment, the plurality of lights 38 comprises red light emitting diodes 44 and blue light emitting diodes 46 and the outer casing 26 is transparent. In either embodiment, the housing 12 appears purple.

A switch 48 is operationally coupled to the power module 34 and the plurality of lights 38. The switch 48 is coupled to and positioned through the housing 12. The switch 48 is configured to be accessed by the user through the cavity 30 to activate the plurality of lights 38. A controller 50 is coupled to the housing 12 and positioned in the internal space 32. The controller 50 is operationally coupled to the switch 48 and the plurality of lights 38. The controller 50 is configured to induce a flashing effect to the plurality of lights 38.

A port 52 is coupled to and positioned in the housing 12. The port 52 is configured to be accessed through the cavity 30 to recharge the power module 34. Preferably, the port 52 comprises a universal serial bus port 54.

A fastener 56 is coupled to the bottom 14 and is configured to couple the housing 12 to the exterior surface of a vehicle. The fastener 56 comprises a magnet 58 that is coupled to the bottom 14. Preferably, the magnet 56 comprises a strip magnet 60 that extends between the inner perimeter 20 and the outer perimeter 16. A gasket 62, which is flexible, is coupled to an outer edge 64 of the magnet 58. The magnet 58 is configured to magnetically couple the housing 12 to the surface of a vehicle and to compress the gasket 62 between the housing 12 and the vehicle, sealing the housing 12 to the vehicle.

In use, the cavity 30 is configured to be accessed by the user to engage the switch 48 to turn on the plurality of lights 38. The fastener 56 coupled to the bottom 14 is configured to couple the housing 12 to the surface of a vehicle. Additional detachable vehicular lighting devices 10 are configurable to be attached to additional vehicles, such that multiple vehicles are identifiable as a group or caravan when traveling.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A detachable vehicular lighting device comprising:
a housing, said housing comprising:
a bottom, said bottom being substantially rectangular and having an outer perimeter, said bottom having an opening defining an inner perimeter,
an outer casing, said outer casing being coupled to said outer perimeter and extending transversely from said bottom,
an inner casing, said inner casing being coupled to said inner perimeter, said inner casing coextending with said outer casing, said inner casing defining a cavity positioned in said bottom of said housing, and
said bottom, said outer casing and said inner casing defining an internal space;
a power module, said power module being coupled to said housing and positioned in said internal space;
a plurality of lights, said lights being coupled to said housing and positioned in said internal space, said lights being operationally coupled to said power module;
a switch, said switch being operationally coupled to said power module and said plurality of lights, said switch being coupled to and positioned through said housing;
a fastener; said fastener being coupled to said bottom, said fastener being configured to couple said housing to the exterior surface of a vehicle.

2. The device of claim 1, further including said bottom having corners, said corners being rounded.

3. The device of claim 1, further including said bottom having a pair of elongated sides.

4. The device of claim 1, further including said outer casing being rounded, such that said housing is domed.

5. The device of claim 1, further including said housing being rigid.

6. The device of claim 1, further including said housing comprising plastic.

7. The device of claim 1, further including said housing comprising hardened plastic.

8. The device of claim 1, further including said power module comprising at least one battery.

9. The device of claim 1, further including said plurality of lights comprising light emitting diodes.

10. The device of claim 1, further comprising:
said plurality of lights comprising white light emitting diodes;
said outer casing being absorbent of light except red light and blue light; and
wherein said housing appears purple.

11. The device of claim 1, further comprising
said plurality of lights comprising red light emitting diodes and blue light emitting diodes;
said outer casing being transparent; and
wherein said housing appears purple.

12. The device of claim 1, further including a controller, said controller being coupled to said housing and positioned in said internal space, said controller being operationally coupled to said switch and said plurality of lights, such that said controller is configured to induce a flashing effect to said plurality of lights.

13. The device of claim 1, further including a port, said port being coupled to and positioned in said housing, such that said port is configured to be accessed through said cavity for recharging said power module.

14. The device of claim 13, further including said port comprising a universal serial bus port.

15. The device of claim 1, further including said fastener comprising:
a magnet, said magnet being coupled to said bottom, and
a gasket, said gasket being flexible, said gasket being coupled to an outer edge of said magnet, such that said magnet is configured for magnetic coupling to the surface of a vehicle and wherein said gasket is compressed between said housing and the vehicle and sealing said housing to said vehicle.

16. The device of claim 15, further including said magnet comprising a strip magnet extending between said inner perimeter and said outer perimeter.

17. A detachable vehicular lighting device comprising:
a housing, said housing comprising:
a bottom, said bottom being substantially rectangular and having an outer perimeter, said bottom having an opening defining an inner perimeter, said bottom having corners, said corners being rounded, said bottom having a pair of elongated sides,
an outer casing, said outer casing being coupled to said outer perimeter and extending transversely from said bottom, said outer casing being rounded, such that said housing is domed,
an inner casing, said inner casing being coupled to said inner perimeter, said inner casing coextending with said outer casing, said inner casing defining a cavity positioned in said bottom of said housing, and
said bottom, said outer casing and said inner casing defining an internal space;
said housing being rigid, said housing comprising plastic, said housing comprising hardened plastic;
a power module, said power module being coupled to said housing and positioned in said internal space, said power module comprising at least one battery;
a plurality of lights, said lights being coupled to said housing and positioned in said internal space, said lights being operationally coupled to said power module, said plurality of lights comprising light emitting diodes;
a switch, said switch being operationally coupled to said power module and said plurality of lights, said switch being coupled to and positioned through said housing, such that said switch is configured to be accessed by the user through said cavity to activate said plurality of lights;
a controller, said controller being coupled to said housing and positioned in said internal space, said controller being operationally coupled to said switch and said plurality of lights, such that said controller is configured to induce a flashing effect to said plurality of lights;
a port, said port being coupled to and positioned in said housing, such that said port is configured to be accessed through said cavity for recharging said power module, said port comprising a universal serial bus port;
a fastener; said fastener being coupled to said bottom, said fastener being configured to couple said housing to the exterior surface of a vehicle, said fastener comprising:
a magnet, said magnet being coupled to said bottom, said magnet comprising a strip magnet extending between said inner perimeter and said outer perimeter, and
a gasket, said gasket being flexible, said gasket being coupled to an outer edge of said magnet, such that said magnet is configured for magnetic coupling to the surface of a vehicle and wherein said gasket is compressed between said housing and the vehicle and sealing said housing to said vehicle;
wherein said cavity is configured to be accessed by the user to engage said switch to turn on said plurality of lights, and said fastener coupled to said bottom is configured for coupling said housing to the surface of a vehicle, and wherein additional said detachable vehicular lighting devices are configurable to be attached to additional vehicles, such that multiple vehicles are identifiable as a group or caravan when traveling.

18. The device of claim 17, further comprising:
said plurality of lights comprising white light emitting diodes;
said outer casing being absorbent of light except red light and blue light; and
wherein said housing appears purple.

19. The device of claim 17, further comprising
said plurality of lights comprising red light emitting diodes and blue light emitting diodes;
said outer casing being transparent; and
wherein said housing appears purple.
